(19) United States
(12) Patent Application Publication
(10) Pub. No.: US 2009/0151801 A1
(43) Pub. Date: Jun. 18, 2009

(54) METHOD, SYSTEM AND APPARATUS FOR AN EFFICIENT DESIGN AND OPERATION OF A PUMP MOTOR

(76) Inventors: John Gorman, Encinitas, CA (US); William Lizalde, Oceanside, CA (US); Robert Kulakowski, Rancho Santa Fe, CA (US)

Correspondence Address: Bob Kulakowski, 2792 Loker Avenue W, Suite 106, Carlsbad, CA, 92010, US

(21) Appl. No.: 12/333,494

(22) Filed: Dec. 12, 2008

Related U.S. Application Data
(60) Provisional application No. 61/013,280, filed on Dec. 12, 2007.

(51) Int. Cl. G05D 7/06; H02P 7/00

(52) U.S. Cl. 137/565.11; 137/563; 137/565.16; 137/565.29; 318/432; 318/434

(57) ABSTRACT

A method of operating a controller for a pool pump motor includes the steps of setting an operating mode for the pool pump motor, setting a torque value for the pool pump motor corresponding to the operating mode, setting a high operating threshold and a low operating threshold corresponding to the torque value, operating the pool pump motor in a constant torque mode using the torque value, monitoring an operating parameter of the pool pump motor corresponding to a load on the pool pump motor, discontinuing operating the pool pump motor when the operating parameter is higher than the high operating threshold or lower than the low operating threshold and signaling a pool pump motor fault upon the discontinuing operating the pool pump motor. The operating parameter of the pool pump motor is RPM or current supplied to the pool pump motor. Additionally disclosed are energy efficient pool hydraulic design techniques that increase the energy efficiency of hydraulic systems.

### CROSS-REFERENCE TO RELATED APPLICATIONS

The present Utility patent application claims priority benefit of the U.S. provisional application for patent Ser. No. 61/013,280 filed on Dec. 12, 2007 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to an efficient pool design. More particularly, the invention relates to efficient hydraulic design techniques and more efficient pump motor control techniques.

### BACKGROUND OF THE INVENTION

The hydraulics and controls for modern day swimming pools is based on design concepts that originated in the 1960s and have remained fairly stagnant. Conventional pool designs can be characterized as inefficient due to a combination of inefficient hydraulic designs that require a high-power pump to move water through the system at high speed and at high pressure. Each year there are pool related drowning fatalities resulting from the high pressures and high suction forces found in 2″ diameter pools when hair, clothing, or body parts are sucked into the 2″ diameter pools hydraulic system water inlets. The suction found in 2″ diameter pools is so strong that individuals cannot overcome the suction force to free themselves and are held underwater. The high suction force in a 2″ pool system is the results from the high water pressure and high water velocity required to move sufficient volumes of water to keep a pool hygienically clean. Furthermore the pumps used in conventional systems may be more efficient at flow rates different than those supported by the conventional pool system components such as filters, vacuum breakers, heaters, applied pipe dimension, valves, etc. In the past designs for an efficient pool motor is exemplified by timing the operation of a two-speed motor and does not provide a solution that can increase the efficiency of a single speed pump. It does not address improved hydraulics, multiple pump priming, or a method of improving the efficiency of single speed motors that are common in conventional pool designs.

In view of the foregoing, there is a need for improved techniques for pool hydraulic systems and power control systems for increased pool energy efficiency and safety.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a simplified diagram of a hydraulic design of a prior art pool;

FIG. 2 is a simplified diagram of an exemplary hydraulic design in accordance with an embodiment of the present invention;

FIG. 3 is a simplified diagram of an exemplary hydraulic design utilizing two pumps in accordance with an embodiment of the present invention;

FIG. 4 shows a simplified diagram of a pool controller connecting to a motor in the prior art;

FIG. 5 show an exemplary diagram the connection of a VCS to a pool controller and a motor in accordance with an embodiment of the present invention;

FIG. 6 is a block diagram of an exemplary VSC in accordance with an embodiment of the present invention;

FIG. 7 is a schematic diagram of an exemplary hydraulic design utilizing two pumps in accordance with an embodiment of the present invention;

FIG. 8 is a schematic diagram of an exemplary hydraulic design with a fluid bypass compensation and a spa bypass in accordance with an embodiment of the present invention;

FIG. 9 is an exemplary simplified diagram of a hydraulic system for a pool;

FIGS. 10A and 10B depict exemplary “T” connectors in accordance with embodiments of the present invention;

FIG. 11 shows an exemplary pool design in accordance with an embodiment of the present invention;

FIG. 12 is a flow chart for an exemplary Torque Mode operation in accordance with an embodiment of the present invention; and

FIG. 13 is a flow diagram of an exemplary process of pump priming in accordance with an embodiment.

Unless otherwise indicated illustrations in the figures are not necessarily drawn to scale.

### SUMMARY OF THE INVENTION

To achieve the forgoing and other objects and in accordance with the purpose of the invention, a method, system and apparatus for an efficient design and operation of a pool is presented.

In one embodiment, a method of operating a controller for a pool pump motor is presented. The method includes the steps of setting an operating mode for the pool pump motor, setting a torque value for the pool pump motor corresponding to the operating mode, setting a high operating threshold and a low operating threshold corresponding to the torque value, operating the pool pump motor in a constant torque mode using the torque value, monitoring an operating parameter of the pool pump motor corresponding to a load on the pool pump motor and discontinuing operating the pool pump motor when the operating parameter is higher than the high operating threshold or lower than the low operating threshold.

Another embodiment further includes the step of signaling a pool pump motor fault upon discontinuing operating of the pool pump motor. In other embodiments the operating parameter of the pool pump motor is RPM and the operating parameter of the pool pump motor is current supplied to the pool pump motor. The method includes the steps of setting an operating mode for the pool pump motor, setting a RPM value for the pool pump motor corresponding to the operating mode, setting a high current operating threshold corresponding to the normal operating current, and setting a low current operating threshold corresponding to the normal operating current, operating the pool pump motor and discontinuing operating the pool pump motor when the operating parameter is higher than the high operating threshold or lower than the low operating threshold.

In yet other embodiments, the step of monitoring further includes monitoring sensors to determine if a blockage exists for the pool pump motor and the step of discontinuing further includes discontinuing operating the pool pump motor when the blockage exists. In another embodiment the sensors are a flow sensors. In still other embodiments, the step of operating the pool pump motor further includes setting a runtime for the operating at least based in part on a temperature of water in a pool and the setting a runtime is further based in part on a seasonal time of year. In another embodiment the controller for a pool pump motor is configured to control at least a first pool pump motor and a second pool pump motor, the method further includes the steps of turning on the first pool pump motor, operating the first pool pump motor at a first high speed to prime the first pool pump motor, turning on the second pool pump motor, operating the second pool pump motor at a second high speed to prime the second pool pump motor and reducing the first high speed of the first pool pump motor and the second high speed of the second pool pump motor after both the first pool pump motor and the second pool pump motor have been primed, the reducing occurring generally simultaneously to mitigate effects of one pump's output overpowering another pump's output. Yet another embodiment further includes the step of fine tuning a first operating speed of the first pool pump motor and a second operating speed of the second pool pump motor. Another embodiment further includes the step of monitoring sensors to determine when the first pool pump motor and the second pool pump motor have been primed. Still another embodiment further includes the step of equalizing a flow rate between the first pool pump motor and the second pool pump motor, the flow rate equalizing using the sensors so that there is sufficient pump output back pressure on the first pool pump motor and the second pool pump motor to avoid the first pool pump motor and the second pool pump motor from running dry.

In another embodiment a variable speed controller configured to control at least a first pool pump motor and a second pool pump motor is presented. The variable speed controller includes a variable speed motor circuitry for in communication with the first pool pump motor and the second pool pump motor for operating the first pool pump motor and the second pool pump motor at a plurality of different speeds. A system controller is in communication with the variable speed motor circuitry, the system controller being configured to signal the variable speed motor circuitry to turn on the first pool pump motor, operate the first pool pump motor at a first high speed to prime the first pool pump motor, turn on the second pool pump motor, operate the second pool pump motor at a second high speed to prime the second pool pump motor and reduce the first high speed of the first pool pump motor and the second high speed of the second pool pump motor after both the first pool pump motor and the second pool pump motor have been primed, the signaling to reduce occurring simultaneously to mitigate effects of one pump's output overpowering another pump's output. In yet another embodiment the system controller is further configured to signal the variable speed motor circuitry to operate the first pool pump motor and the second pool pump motor in a constant torque mode, monitor an operating parameters corresponding to loads on the first pool pump motor and the second pool pump motor and discontinue operating the first pool pump motor and/or the second pool pump motor when one of the operating parameters exceeds an operating threshold.

In another embodiment a hydraulic system for a pool is presented. The hydraulic system includes a first water inlet from the pool. A first pool pump motor has a first input and a first output. The first input is connected to the first water inlet. The hydraulic system includes a second water inlet from the pool. A second pool pump motor has a second input and a second output. The second input is connected to the second water inlet. A connection combines water from the first output and the second output to provide a combined water feed to the pool one pool accessory or the pool and one or more pool accessories. Another embodiment further includes a fluid bypass for bypassing a portion of the water feed from an input to an output of the pool or accessory or pool and accessory. In still another embodiment the first water inlet is above the first pool pump input and gravity feeds water into the first pool pump motor in a flooded-suction manner. Another embodiment further includes an energy generating turbine inline between the first water inlet and the first pool pump input where the turbine generates electricity. Yet another embodiment further includes a variable speed controller configured to control at least the first pool pump motor and the second pool pump motor, the variable speed controller including a variable speed motor circuitry for operating the first pool pump motor and the second pool pump motor at a plurality of different speeds and a system controller in communication with the variable speed motor circuitry, the system controller being configured to signal the variable speed motor circuitry to operate the first pool pump motor and the second pool pump at the plurality of different speeds to prime the first pool pump motor and the second pool pump.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

In the description herein the term pool component, component or system component is used to identify any one of a number of parts or devices used in pool systems, including, but not limited to, hydraulic components such as, without limitation, pipes, connectors, valves, etc., filters such as, without limitation, sand, membrane, or earth or other, heaters, backflow prevention devices, vacuum breakers, and other parts or subsystems. The terms pump and motor are used interchangeably.

The use of certain pipe dimensions in the description is for illustrative purposes and should not be used to limit the invention to only the dimensions given in the examples. The use of 3″ diameter plumbing is used to indicate a larger pipe size than standard 2″ diameter based pool systems used for residential swimming pool applications. Likewise, references to 3″ diameter hydraulics or plumbing refer to a pool designed in accordance with embodiments described herein, and 2″ plumbing will refer to conventional pools designed without the novel methods provided herein.

The use of 3″, 3″ system, 3″ pipe, 3″ plumbed, or 3″ diameter is intended to provide exemplary language for increased efficiency pool designs based on the teachings herein. As set forth in the foregoing description, the invention is not limited to 3″ diameter plumbing. Likewise, 2″, 2″ pipe, 2″ plumbed, 2″ system, or 2″ diameter is used to refer to inefficient conventional pool designs not incorporating the novel aspects of embodiments described herein. While a residential backyard pool application is used as an example, the embodiments described herein are not be limited to only residential swimming pool applications. The embodiments are applicable, without limitation, to commercial pools, fountains, aquariums, ponds, water displays, and other pumping, hydraulic, and liquid related applications. Additionally, the embodiments are scalable to support more efficient pool operation of larger pools by adding multiple pumps operating in parallel with any combination of pool components.

Likewise, as set forth in the foregoing description, the embodiments are not limited to 3″ diameter plumbing and are applicable to other pipe diameters. In the description the 3″ designation for any part will be used to refer to a part or parts used in a pump efficient hydraulic system design that results in pump optimized flow rates that maximize system flow rates while consuming minimum energy. A legacy design that is referred to as 2″ is based on a design wherein pipe dimension and coupling dimensions determine the pool hydraulic system dimensions.

It should be appreciated that the novel elements contained within embodiments are applicable for incorporation into pool controllers, pumps, or in standalone hardware devices that connect between pump motors and pump power. The term “pool controller” herein refers to what can typically be described as a computer based or logic based controller used to control such as, but not limited to, the turning on and off of the power to the pump or controlling the motor starting and stopping based on pool controller output signals. The term pool controller is used to describe a control element that can be located anywhere within a pool system including, but not limited to, being a part of a standalone computer based pool control that includes a display panel, and is used for controlling the selection of filter modes such as, but not limited to, Service Mode, Spa Mode, etc. as well as providing other pool or pump related control. In addition, pool controller or controller can be incorporated into hardware or software within a pump itself, within a standalone logic circuit external to the pump or computer controller or distributed across one or more of these elements. The term “high voltage” is used to indicate the rated operating voltage of the motor For example, without limitation, 240 VAC, or 110 VAC, or 24 VDC, or 12 VDC. Also, the term ‘inlet’ or water source is used to describe any type of one or more fluid connections used to provide water to pumps, heaters, filters, and other components used in pools. A water inlet or a group of inlets are fluid connections from the pool floor, pool sides, pool skimmer(s), vacuum hose connectors, spillway, vanishing-edge gutters, or from a overflow spill tank or any other suitable location containing water.

Conventional pools are generally based on 2″ diameter pipes and use high-pressure and high water velocity to move the necessary amount of water to properly clean the pool. The plumbing for a 2″ diameter pool is easy to design because the basic hydraulic design has been proven over the last 30 years and pool contractors understand the design. However, the legacy 2″ diameter pools do not offer the energy efficiency operation, increased safety, increased pool reliability and improved water filtration offered by the novel elements of embodiments described herein. The fact that a 2″ pool will operate less efficiently than a 3″ pool incorporating the many novel elements of the present invention is counter intuitive. This is at least because one skilled in the art would assume that a 2″ pool can use a smaller motor than when compared to a 3″ pool because the pump in a 2″ system is operating with less work load on the pump resulting in the application of a smaller pump. This would be true without the novel elements provided by the preferred embodiment of the present this invention.

This invention incorporates a larger (e.g. 3″) diameter hydraulic system for the hydraulic design of pools and water pumping systems. Additional novel aspects of certain embodiments of present invention include flow-rate compensation plumbing and pump control techniques that allow pools to be designed more efficiently when all the pool components do not support 3″ fluid connections.

In many applications, pool safety is increased when at least the novel steps, taught herein, are applied to a pool because the water pressures and suction forces associated with 3″ diameter plumbing are significantly lower when compared to a 2″ system.

In one novel preferred embodiment, 3″ diameter plumbing is used with variable speed pump motors to achieve an energy efficient pool system. Preferred embodiments include pump priming techniques that provide reliable pump priming when using 3″ diameter a process that is much more difficult to achieve than when compared to priming pumps in a 2″ diameter system. The pump priming techniques allow multiple pumps to operate at much lower power levels with the larger 3″ diameter plumbing than what can be achieved with 2″ plumbing. In preferred embodiments the pump priming process automates the difficult process of switching from high speed pump operation to low speed operation and equalizes the water flow through each pump preventing one pump from overpowering a second pump when operating in parallel.

Energy consumption tests have been performed using a variety of 2″ plumbed pools and the resulting data reveals that the pumps in these pools operate with 7 to 12 amps of current per pump at 240 volts. The pumps utilized in 2″ systems are operating at or near peak horsepower output because peak pump power is generally required to move sufficient volumes of water and generate enough pump head pressure to properly filter the pool. Reducing the RPMs on the 2″ system pumps may decrease water flow rates to unacceptable levels and the pool filtration system will not be capable of keeping the pool water hygienically acceptable because not enough water will be filtered using conventional pool pump schedules.

By using a 3″ diameter pool hydraulic design and the pump priming and control methods in accordance with preferred embodiments of this invention, pool energy consumption has been measured at as little as 0.4 to 2 amps per pump resulting in dramatic energy savings. Not only is the energy consumption associated with a 3″ pool dramatically decreased, the life of the pool equipment including pumps, skimmers, and filters is increased because of the reduced pressure, and pool safety is enhanced through the reduction of hazardous suction forces generated in the 2″ systems that can lead to fatal drowning accidents.

In a preferred embodiment, another novel element is the detection of a potentially hazardous condition within the filtering system wherein hair or a body part of a person or animal is sucked into the pool filtration system entrapping an individual or an animal underwater and resulting in drowning.

Additionally, pools designed using the methods described herein are more hygienically clean because more dirt is moved by the system due to the increase in water flow through the system and more pool dirt is suspended in water motion for filtration by the pool filter.

Another attendant aspect of the present embodiment is that separate hot tub back jet motors used to generate the high-pressure water streams found in hot tubs and spas can be eliminated. Eliminating a pump in a pool system results in a lower cost pool design. Additionally, less pump motors are generally required for larger pools because the flow rates though the pump in a 3″ system are much higher than that of a 2″ system.

Hydraulic Design

Preferred embodiments of the present invention provide for a more efficient pool design based on 3″ plumbing. While there may be similarities in the design of 2″ and 3″ pool systems from a hydraulic schematic design standpoint, embodiments of the present invention include novel elements that make the 3″ design reliable, and more efficient to operate when compared to a 2″ pool. Obviously the dimension of the pipes used in the design is one of the main differences. The components used in the 2″ and 3″ pool designs are similar and both designs include standard pool components such as, but not limited to, a pool or water filter, a pump or multiple pumps, valves, backflow device, and other component.

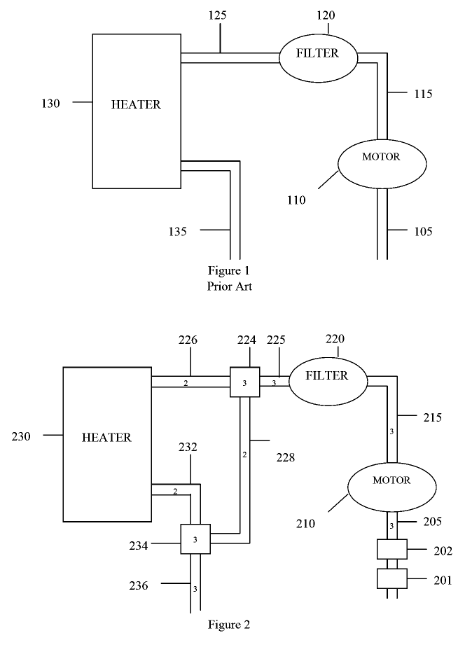

FIG. 1 illustrates an exemplary simplified diagram of a hydraulic design of a prior art pool. In FIG. 1 water is input to Motor 110 through fluid connection 105. Motor 110 output connects to Filter 120 via fluid connection 115. Filter 120 output connects to heater 130 via fluid connection 125. Heater 130 output connects to other system component or to the return line to the pool via fluid connection 135. FIG. 1 is a simplified diagram of a conventional pool and the fluid connections 105, 115, 125, and 135 and other connections in conventional pool systems is based on 2″ or a 2.5″ or a combination of 2″ and 2.5″ pipe. FIG. 1 is simplified diagram and in a real system there will be other pool components such as back flow prevention devices and other devices not shown. FIG. 1 is used to illustrate that the fluid connections are 2.5″ diameter or smaller and there is no fluid compensation bypass.

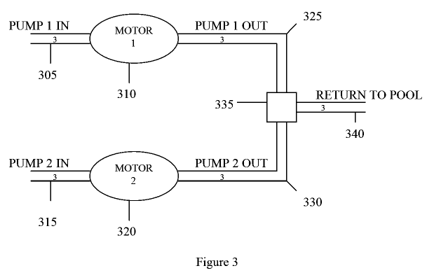

FIG. 2 illustrates a simplified diagram of an exemplary hydraulic design in accordance with an embodiment of the present invention. In FIG. 2 a 3″ diameter system is shown with fluid connections 205, 215, and 225 being 3″ versions of the FIG. 1 connections. However, in FIG. 2 the Filter 220 output connection 225 does not connect directly to heater 230 but rather connects to a fluid ‘T’ connection 224. Fluid ‘T’ connector 224 is a 3″ input and 3″ ‘T’ connector that feeds output 226 and 228. Connection 226 is a 2″ connection to heater 230 and connection 228 is a 2″ fluid bypass that compensates for the reduced flow through heater 230 due to 2″ connection on the heater. Fluid bypass connection 228 is a 2″ pipe and connects to 3″ ‘T’ connection 234. ‘T’ connector 234 mixes the heater 230 output shown as connector 232 a 2″ connection with the fluid connection 228 and the mixed waters are output from ‘T’ connector 234 via fluid connection 236. The two ‘T’ connections in FIG. 2, 224 and 234, are 3″ ‘T” instead of a 2″ ‘T’ connection. If elements 224 or 234 in FIG. 2 were 2 inch ‘T’ connection a reduced system water flow would limit the achievable efficiency of the hydraulic design. Energy generating turbine 201 is incorporated in some embodiments to generate electricity from the water flow. Sensor 202 is an optional flow sensor or pressure sensor. Sensor 202 is shown on the input of motor 210 but could be located on the output of the pump or any where in the hydraulic system where flow rate or pressure can be measured.

A pool designed with 3″ pipes may, depending upon the needs of the application, require additional plumbing to maintain adequate water flow through the hydraulic system in the form of water flow rate compensation plumbing. Flow rate compensation plumbing is used to compensate for the increased water flow of a 3″ pipe when compared to a 2″ pipe and is used when a combination of equipment with 2″ and 3″ pipe couplings and connectors are found in a system. Put another way, flow rate compensation allows the entire system flow to be based on 3″ plumbing while parts of the hydraulic system use only 2″ plumbing and support only 2″ flow rates. Furthermore, by establishing a high total system flow rate the pool pumps can run at a lower motor RPM resulting in reduced operating costs.

In a preferred embodiment the pool hydraulic lines are based on 3″ diameter pipes and 3″ diameter pipe connectors throughout the system when connecting to the filter components, pumps, valves, backflow devices and other pool components. Use of 3″ diameter pipes provides for increase system water flow when compared to 2″ pipes and the increase water flow allows for the application of reduced system water pressures. However, generally, the application of 3″ plumbing does require pump priming procedures that are very different than that currently used in 2″ systems, and these priming procedures will be discussed in greater detail later in this application.

In other preferred embodiments for designs where all the pool or system components do not support 3″ couplings an exemplary design is to use as much 3″ plumbing as possible and apply the appropriate pipe diameter conversions where needed to maintain the larger pipe dimension water flow while not forcing too much water through smaller diameter pipe or system components not supporting the maximum water flow rate in the hydraulic system. For such designs wherein a mixture of 3″ and 2″ plumbing is found, flow rate compensators as discussed later in this application may be necessary.

In preferred embodiments, pool system efficiency is enhanced by utilizing the greater flow resulting from the application of 3″ plumbing coupled with pump priming and motor control speed and other control techniques described in other sections of this application. Greater flow coupled with the novel elements described herein results in a system that allows the pump motor to be operated at the pump motors most efficient operating levels in terms of power consumption and water flow rates.

For the pump or pumps to operate efficiently the hydraulic system needs to be designed to provide flow rates optimized for the efficient pump operation. Pump optimized flow rates may be very different than flow rates supported by an individual system component. This means that the hydraulic system should first be sized to operate the pumps at their most energy efficient operating levels and flow rates and not size the hydraulic system on the dimensions of any single system component used in the hydraulic system. For example, without limitation, while a filter component may be limited to only 2″ connections using 3″ main lines for water inlet and returns results in improved pumping efficiency even though the filter only supports a 2″ connection and 2″ pipe based flow. Because of the potential mismatch in system component flow rates or fluid connection dimensions, one of the novel elements of certain embodiments of present invention is the use of different size plumbing between the various pool components wherein the largest pipe dimensions used in the system is sized to achieve flow rates that allow the pumps to operate at the most efficient level. In most pool designs this means that the main water lines will be dimensioned to achieve optimum flow rates through the pump and not by matching all of the pipe dimensions used in the system to the minimum connection pipe diameter of say a filter or heater or pump connection or other system component fluid connection dimension. In a non-limiting example, the optimum flow rate for a pump may be achieved using 3″ pipe and a pump operating at 1300 RPMs even though this flow rate may be too high for the 2″ connection of the filter. In the case where the main plumbing flow rate is too much for a system component one element of preferred embodiments incorporates flow rate compensators into the pool design. Flow rate compensators provide water flow bypasses of system components that cannot handle the 3″ pool flow rates and this additional water bypass allows the pool pump to operate at a much higher flow rate than system components. This higher flow rate will allow the pump to operate at the pumps peak efficiency resulting in lower pump operating costs in terms of electricity and pump wear and tear. The flow rate compensators provide water bypass to maintain the normally unsustainable flow rates due to system components with smaller fluid connections and lower flow rates. While the pump in the example above may be most efficient with flow rates supported by 3″ pipe, the pump maybe highly inefficient with the pressure and water velocity needed to adequately filter a pool with 2″ pipes used throughout because the pump is not operating at its most efficient power/flow ratio and the pump must work in a much less efficient mode creating high water pressure and high water velocity due to the restrictive 2″ pipes.

One way of achieving improved pool system efficiency is by having balanced system pump-optimized flow rates with flow-rate compensation included in the design. The flow-rate compensation bypass, shown in FIG. 2, creates a second fluid connection 228 to divert some of the water from the larger pipe diameter 225 when connecting to a smaller pipe diameter 226. The flow-rate compensation bypass is used to maintain consistent system flow rates through the entire system and to compensate for the smaller diameters reduced water flow rate through heater 230 via connections 226 and 232. For example, without limitation, in some systems where commercial parts do not have 3″ fittings when 3″ main plumbing is used, a reduction fitting for 3″ pipe to 2″ pipe is generally required to connect the 3″ main plumbing to the 2″ system component. However the 2″ component will reduce the system water flow and additional plumbing is generally required to keep the 3″ system flow from being restricted by the 2″ system component. Exemplary flow rate compensation is provided in FIG. 2 by an additional fluid bypass pipe connection 228 or manifold (not shown) to provide an additional fluid path to compensate for the flow loss in the 3″ to 2″ fitting connection supported by heater 230. For example, without limitation, if a 2″ pipe connection is found on a pool water heater 230 with connection 226 for input to heater and 232 for output from the water heater, then a 3″ to 2″ fitting is generally required when using 3″ pipes for the main hydraulics 225 along with a separate 3″ to 2″ heater flow rate compensation bypass fluid path 228 to maintain the flow rates achieved from the 3″ diameter pipe. The flow-rate compensator plumbing in this example compensates for the flow rate restriction resulting from 2″ fittings on the heater by bypassing some of the water from the 3″ main. The two two-inch fluid paths 226 and 228 are recombined by a 3″ ‘T’ shown as 234 in FIG. 2, with ‘T’ connection 236 containing the mixed waters from connections 232 and 228. Standard flow-rate tables for various pipe dimensions can be used to determine the appropriate flow-rate compensation required by the flow-rate compensation fluid connection. While the above example demonstrated flow-rate compensation between 3″ and 2″ diameter plumbing, the invention includes support for other pipe-dimensions and flow-rate compensation designs and the invention should not be limited by the example plumbing pipe dimensions. For example, without limitation, flow-rate compensation bypasses support for 4″ to 2″ or 3″ to 1″ or 3″ to 1.5″ or other diameter pipe connections and appropriate bypasses is contemplated by this invention. An example, without limitation, of the flow-rate compensation bypass for a 3″ plumbing system to a 2″ heater would be a 3″ to 2″ reduction connection from the main 3″ plumbing along with a 3″ to 2″ heater bypass connection as shown in FIG. 2.

For many pool pumps the most efficient pump operation is achieved at low RPM and the preferred embodiment of the invention provides a hydraulic system designed to allow the pump to operate at low RPMs because the hydraulic design provides sufficient flow rates for filtering a pool while operating a pump at low RPMs. Additionally, by using two or more pumps in parallel this system allows for the sharing of the work by two or more pumps both running at a lower RPM resulting in lower energy consumption than the power consumption of a single pump system. Depending on the size of the pool, running a single pump at low RPM may result in inadequate water flow to properly filter a pool, therefore a two pump system will deliver adequate water flow for proper filtration with lower power consumption when compared to a one pump system.

Additional overall system costs in a one pump pool system is reduced by other novel elements of embodiments of the invention because the jet pump normally associated with a spa can be eliminated by the hydraulic design of the system. The single pump can deliver sufficient water volume and pressure to the spa. In conventional 2″ pool spa hydraulic designs a separate high power pump is employed to generate sufficient jet pressure. Preferred embodiments of the present invention utilize the additional flow rate provided by 3″ plumbing to eliminate the separate jet pump. When a single pump as described in this invention is employed for both pool filtration and spa jet pump operation appropriate valves will be employed to allow the single pump to operate in different modes including filter pool only, filter pool and spa, spa only mode, pool filtering mode and other modes of pool hydraulic operation normally found in conventional pools, where each of these different modes can operate at a mode efficient RPM.

In a preferred embodiment of the invention the filtered water returning to the pool from the water filter is returned at the bottom of the pool. Returning the water from the bottom of the pool improves water filtration performance and greatly reduces the drowning risk potential because a person cannot be held down at the bottom of the pool by the water suction force found at the pool filtration inlet. Other locations of the filtered water return and inlets for filtered water are contemplated and supported by this invention.

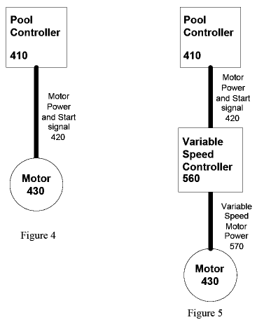

FIG. 3 illustrates a simplified diagram of an exemplary hydraulic design utilizing two pumps in accordance with an embodiment of the present invention. In FIG. 3 the outputs of pumps 310 and 320 are combined at element 335. Element 335 is a 3″ ‘T’ connection that mixes the water from pump 310 and pump 320 into a single mixed water fluid connection 340 that is returned to the pool. Element 335 not only mixes the fluid output of pump 310 and pump 320 but also creates backpressure on each motor. In FIG. 3 pump 310 input fluid is connected to motor 310 via fluid connection 305. Pump 310 output fluid is connected to the fluid mixing point ‘T’ connector element 335 via pipe 325. Pump 320 input is connected via element 315, and the output of motor 320 is connected to fluid mixing ‘T’ connector element 335 via pipe 330. In FIG. 3 all of the connections and pipes are 3″, however a combination of 3″ pipes with 2½″ or 2″ pump motor connections is supported. Having 3″ connections on all the elements of FIG. 3 will result in the most efficient design but other supported diameters of connections and pipes are supported by one novel element of the design. Because a single return 340 back to pool is a 3″ line the connections to mixing element 335 can be 2″ connections because when two 2″ connections are combined at element 335 the total water flow will be adequate for a 3″ return. However, the use of 3″ pipes with 3″ or smaller fluid connections on pumps yields improved hydraulic efficiencies when compared to 2″ or 2½″ pipes, resulting in the operation of motors 310 and 320 at lower RPMs and lower operating energy levels. Pool fluid connections 305 and 315 providing input water from pool to pumps 310 and 320 originate from any location in the pool, such as, but not limited to, from pool skimmer(s), or from a vanishing-edge gutter, or from a overflow spill tank or any other suitable location in, on or around the pool.

It should be noted that FIG. 3 illustrates a simplified diagram of pump load sharing and a mixing point without showing other pool components typically required or used in a pool system. In FIG. 3 other pool components such as, but not limited to, filter and chlorine generator can be added to one portion of the diagram for example in line after pump/motor 310. It should be appreciated that each pump/motor in FIG. 3 may have different components than that for the other pump(s). For example, without limitation, pump 310 can have a filter, chlorine generator and heater while pump 320 can only have a filter in line with pump 320's output. Different combinations for the placement of pool components such as filters, heaters, chlorine generators, etc. are contemplated by this invention and the invention should not be limited by the placement of such components.

Mixing points shown as ‘T’ connections such as element 335 in FIG. 3 can be any type of fluid connection with multiple pipe connections such as a 4 connection pipe or a manifold with the output of 2, 3, or more pumps being combined or mixed into a single return.

A skimmer box in a pool is a water inlet used to fluidly couple the pool water to the pool filtration system water inlet piping. In an exemplary design the 3″ skimmer box is larger than the 2″ skimmer box to accommodate the increased water flow provided by the 3″ diameter plumbing. However, 2″ skimmer boxes maybe used as long as sufficient input water flow is provided by the 2″ skimmer box for the 3″ pool plumbing, or multiple 2″ skimmers used to generate adequate flow for the 3″ pipes.

Additional energy savings benefit is achieved with another novel element of an embodiment of the present invention when flooded-suction is used in the pool hydraulic design. Flooded-suction is a system wherein the water inlet to the pool pump is above the pool pump allowing water to gravity feed into the pump. In such a design the flow rates and water force due to gravity allows the pump motor to operate more efficiently than when the pump must also use pump power to move the water into the inlet of the pump. In yet another novel embodiment, flooded-suction is used to generate electricity with an energy generating turbine or energy generator 201, show by way of example in FIG. 2, added in line between the pool and the water inlet to the motor pump to generate electricity. The large 3″ water line from the pool to the pump allows for sufficient water flow to generate electricity to reduce the energy costs associated with running the pump. Water line pool inlet used to feed water from pool to input side of pump through pipe with attached energy generator 201 between pool and pump motor can be located at one or more locations on the floor of pool, or on any one or more sides of the pool. There are many choices in placing the energy generating turbine used to create electricity including but not limited to between pool water inlet 205 in FIG. 2 and motor 210 in FIG. 2. Fluid connection 205 in FIG. 2 provides connection from the pool to motor 210 and energy generating turbine 201.

FIG. 7 illustrates a schematic diagram of an exemplary hydraulic design utilizing two pumps in accordance with an embodiment of the present invention. FIG. 7 provides an exemplary schematic diagram of a pool with two pumps 710 and 722 and pump workload sharing with pump 710 and 722 outputs being combined to share the filtration pumping work via connections 719 to 718 and 708 to 706 feeding pool return 756 that returns the mixed water pumped by 710 and 722 back through a single line shown as 756 in the diagram. Element 754 is a vacuum break or backflow prevention device. Also shown in FIG. 7 is the water flow rate compensation providing an exemplary bypass to maintain higher flow rates than what is supported by the heater 730 with 2″ water inlet and output. Flow rate compensation for heater 730 includes fluid path 732 and 748. In this figure, support for two different Spa Jets (back jets) is included and shown by way of example as 702 and 704 in the figure. When the spa is not being used water flows out path 708 “floor return 1 pre-mix” to 718 and is combined with Edge pump 722 that filters water spilling over the vanishing pool edge. Water pumped by motor 722 is filtered and combined via connection 718 to 708 wherein floor return2 pre mix is then mixed via ‘T’ connection after 718 and 706 between vacuum break 754 and feeding point 756. Point 756 connects to the floor return in the pool and has the combined water flow from pumps 710 and 722. Combining the water is described in other areas of present description. Water combining utilizes two pumps and shares the pumping work load with each pump operating more efficiently than in a one pump system. Water combining also results in more efficient pump operation in a two pump system when compared to the operation of two pumps in parallel without water combining. FIG. 7 includes exemplary pool connections for Spa Jet1 702, Spa Jet2 704, filter input 712, filter input 716, vacuum connection 714, water input for Spa mode 709, and edge filter 716. Motor 710 pumps water through one portion of the hydraulic system. Motor 722 pumps water through another portion of the hydraulic system. In FIG. 7 air lines for spa 750 and 752 provide air input used to generate bubbles when the hydraulic system is used in Spa mode. Check valves 736 and 726 keep water flowing in the correct direction and prevent water from flowing in the reverse direction.

FIG. 8 illustrates a schematic diagram of an exemplary hydraulic design with a fluid bypass compensation and a spa bypass in accordance with an embodiment of the present invention. Water is input using 3″ line 810 and diverted to two paths 825 and 820 via 3″ T connector 815. 840 provides a bypass for the spa that provides water flow through spa in normal filtration mode. In many pool designs during normal filtration mode water is spilling out of the spa through a water feature such as a waterfall, or water is spilling over the spa edge similar to the way water spills over a vanishing edge.

FIG. 8 also shows by way of example a simplified design of a 3″ water input line connecting to a “salt” based chlorine generator 826 and a heater 830 using 2″ plumbing. While the 2″ connections limits the water flow through the chlorine generator 826 and heater 830water flows through both the heater (even when the heater is turned off) and because of this adequate water flow is achieved to support efficient operation with 3″ input and output lines to the pool. In many practical applications, more efficient operation can be achieved with a system components that supports 3″ connections and high water flow rates. FIG. 8 also shows a 3″ T connection 815 connecting to a 3″ input from 810 and two 3″ outputs from 810 connecting to two 2″ pipes 825 and 820. The use of a 3″ T connection results in more efficient operation than a 2″ T connector. Also incorporated in FIG. 8 is valve 842 that is open to allow water flow through the Spa for filtering or spa spillover.

FIG. 8 also shows ball valve 850 that is used to divert water to the pool floor 862 or the spa (to spa floor 872 and to spa back jets 874), or both pool and spa. During normal daily filtration mode ball valve 850 will be set to divert water to pool floor 862 and spa bypass check valve 842 will be open feeding water to spa ball valve 855. Note that no water will be flowing fed from check valve 850 to spa in normal filtration mode and the water to provide normal water filtration for the spa will flow through open ball valve 842 to ball valve 855 and to spa through either to spa floor 872 or to spa back jets 874 depending upon position of spa ball valve 855. In normal spa filtration mode the clean water will usually be returned via pipe to spa floor 872.

FIG. 9 illustrates another exemplary simplified diagram of a hydraulic system for a pool according to yet another embodiment of the present invention wherein a 2″ filter ‘F’ is connected to 3″ plumbing to the pool and a 3″ plumbed motor M. In FIG. 9 there is no fluid bypass as shown in other figures and FIG. 9 illustrates a less optimized design incorporating a combination of 2″ and 3″ plumbing.

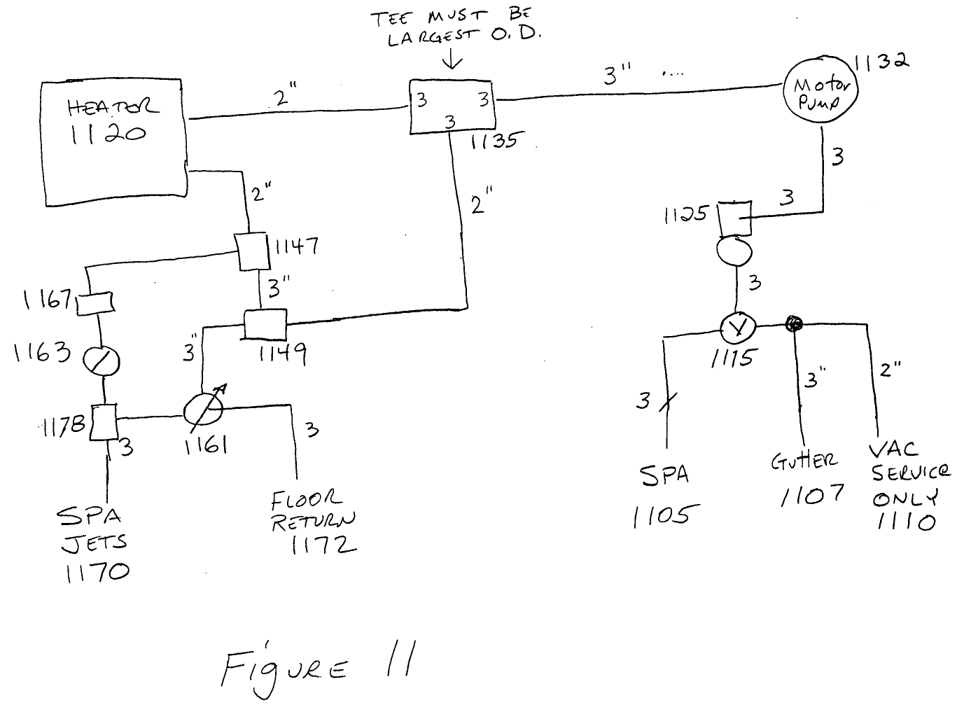

FIGS. 10A and 10B illustrate exemplary “T” connectors in accordance with embodiments of the present invention. To maintain proper water flow through the system the application of pipe connectors and manifolds must be considered. FIG. 10A shows a less efficient ‘T’ connector for incorporation into the hydraulic design. In FIG. 10A the 2-inch ‘T’ restricts the water flow through the ‘T’ to that provided by 2 inch pipe. FIG. 10B shows a more efficient ‘T’ connector sized to the largest input pipe size. In FIG. 10B a 3-inch ‘T’ connector is sized to match the flow rate provided by the largest pipe which is in this example 3″.

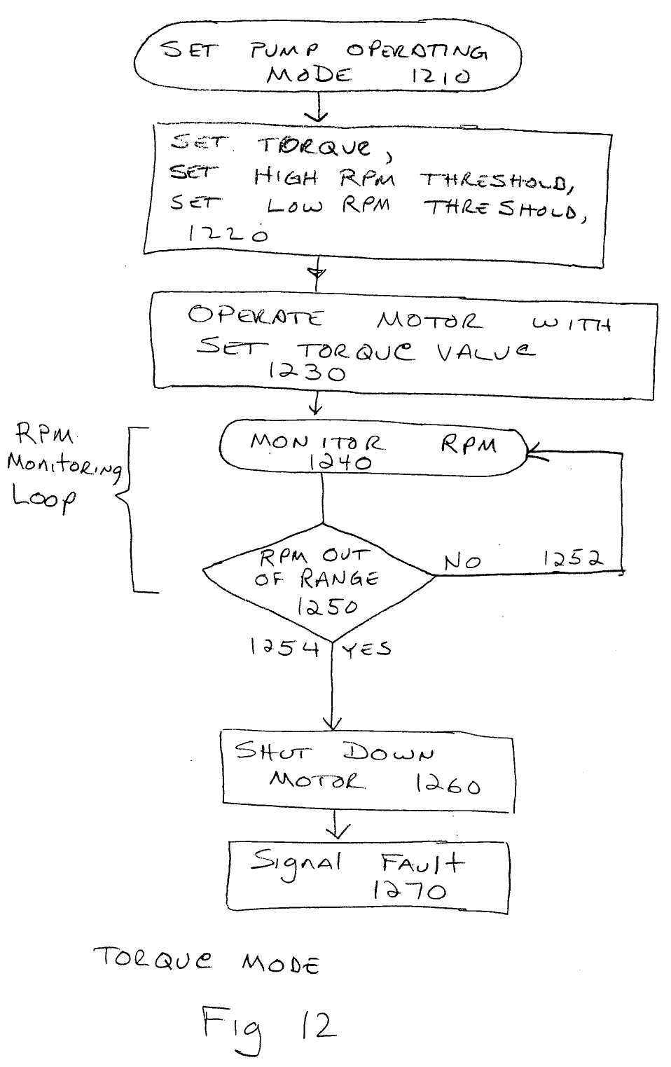

FIG. 11 illustrates an exemplary pool design in accordance with an embodiment of the present invention. FIG. 11 shows a pool design with a single pump and fluid compensation bypass for a heater and typical fluid connections found in conventional pools including connections for spa jets, filtered water fluid return (floor return), gutter, and pool cleaning vacuum connection (VAC Service Only).

Another novel aspect of the preferred embodiment of the present invention is the utilization of water filtration devices (pool water filter) supporting the higher flow rates provided by the hydraulic design. Utilizing filters with increased filtration capacity due to increased flow rate results in even more efficient operation because the number of minutes the filtration system is running to filter the water is reduced, thereby utilizing the increased water flow provided by this system to filter water in less time. Water filtration rate will match the hydraulic system flow rate when the pumps are operating in normal mode, low RPM or filter mode, thereby allowing the system to be designed without the needed to run the pumps for a longer time to compensate for the reduced filter flow rate capacity. In systems with water filters that support high flow rates the normal RPM setting of each pump maybe run a bit higher than in a system wherein the filter does not support high flow rates. The running of the motor at a higher RPM in normal operation results in higher energy cost but the number of run time minutes per day the pump is operating is reduced.

Pump Control

Additional preferred embodiments of the present invention include pool pump motor design and control methods to achieve energy efficient pool operation. The use of 3″ plumbing in pool design creates design challenges with regards to efficient pump design, pump priming, multiple pump priming, pump control, multiple pump coupling, pump RPM reduction, along with other design challenges. Conventional 2″ pool designs wherein the 2″ pipe is replaced with 3″ pipe will require different priming methods for single pump and multiple pump designs and in addition will require flow compensation bypasses as described in other parts of this present description.

The pool pump or pumps utilized in the preferred embodiment of present invention should be primed at higher speed than normal operating/running speed. Higher speed priming allows the hydraulic system to become normalized in that air pockets and air bubbles within the system are pushed out over time. Some pools and pumps are self-priming, for example and without limitation, a flooded suction pool may not require a prime mode after the very first operation of the filter after construction. While the preferred embodiment supports a no priming mode the added priming mode operation at high speed for a few minutes does not consume much energy and may provided added reliability in pools that may have slight air leaks, gasket leaks, or other hydraulic problems. Typically pump priming times will range from a few seconds to several minutes where 2 to 5 minutes is a typical prime time. However, pump priming times can be as short as less than a second to more than 30 minutes and the preferred embodiment should not be limited by pump priming times. After the system is primed the motor RPM operating speed can be reduced resulting in lower energy consumption. When two or more pumps are used in a system each pump is primed separately at a higher rate of full speed and then both pumps will be reduced to lower speed at the same time.

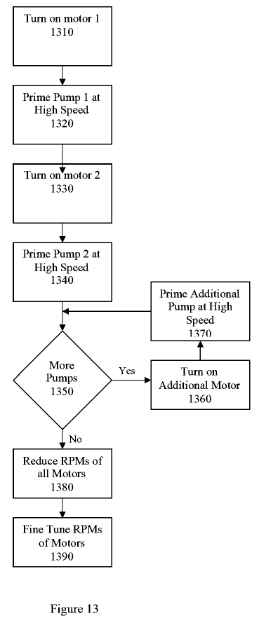

FIG. 13 illustrates a flow diagram of an exemplary process of pump priming in accordance with an embodiment of the present invention. In pool system with two or more pumps, the pump priming process begins at step 1310 where the first pump is turned on. In step 1320, the first pump is primed at a high RPM rate that is at or near full power for the motor. After the pump is primed, the motor is maintained at the high rate. In step 1230, the second pump is turned on. In step 1340, the second pump is primed at a high RPM rate that is at or near full power for the motor. After the pump is primed, the motor is maintained at the high rate. In step 1350 if it is determined an additional pump requires priming, steps 1360 and 1370 turn on the additional pump and prime the pump at a high RPM rate that is at or near full power for the motor. After the pump is primed, the motor is maintained at the high rate. Steps 1360 and 1370 are repeated for each additional pump. In step 1380, after all pumps are primed the RPMs for all pumps are reduced at the same time or at nearly the same time. This step prevents one pump from overpowering the other output of the other pumps. In step 1390, with all pumps operating at reduced RPMs, fine tuning of the RPM speed of each pump can be performed. One pump may need higher RPMs than a second or third pump depending on the pool design for the desired water flow. In some designs the edge pump may need more RPMs than the filter pump or vice-versa.

The above sequence provides an exemplary description of one way of priming the pumps in a multiple pump configurations; however, it is contemplated that wide range of alternative variations to the sequence described above will be readily recognized, in light of the present invention, by one skilled in the art. An example, without limitation, of a slight variation to the above sequence that is contemplated by the preferred embodiment is to change step 1380 above to not immediately reduce the pump RPMs at the same time but rather go through a ramped down RPM reduction step wherein the RPMs of each motor is reduced from high speed operation to reduced normal RPMs with a 20 second ramp. A multiplicity of alternative variations for any of the steps described above are contemplated; by way of example, and not limitation, running the pumps at 90% of full power when priming. Another example, without limitation, of how the sequence can be modified above is by starting with two or more motors running at full speed in step 1310.

The steps described above may only need to be applied at initial pump startup when the pool is being installed, or the steps above may be applied automatically at every pump start time and this will depend on the hydraulic pool and pump design. One alternative embodiment of the invention is to only require pump priming at initial pool startup or after filter or pool servicing to evacuate air from the hydraulic system. Then in every subsequent startup of the pool motors would begin with pump operation at the lower speed and not have to run at full speed. If subsequent pump startups at low speed are not reliable due to air leaking into the plumbing or other reasons the pump start sequence will be similar to that described above or slight variations thereof. An example, without limitation, variation to that described above is that both pumps can be turned on at the same time and prime for a period of time before switching to low speed mode. The pump control sequence described above and in other parts of the present description are supported by adding the hardware or programming logic to implement the described sequence into one or more of the system components used in the pool system including, without limitation, the pool computer controller, pool pump itself, or a separate device that interfaces between a pool controller and pump. While the above exemplary sequences show one pump operating at a different RPM than that of another, support for any pump operating at a lower or higher RPM than another pump is contemplated as well as pumps operating at the same RPM. For systems with 3 or more, two or more pumps can operate at the same RPM or each pump can operate at the same RPM. The novel elements described in the present description should not be limited by the different combinations and permutations in setting a pump operating RPMs in multiple pump installations.

In another novel element, simplified pool maintenance is provided by adding a motor priming sequence similar to, or identical to that described above into a control system, such as but not limited to, the computer control system for the pool, or electronic circuitry used within a pump to control the operation of the pump, or a separate device, or a combination of both. It should be appreciated that the sequence described in FIG. 13 can be performed by any pool or motor related control circuitry, or in conventional computer software or computer firmware or discrete logic circuitry with or without feedback between multiple pumps in such configurations. In other embodiments, an advanced version of the pump control circuitry contemplated in the preferred embodiment monitors the flow of water through each pump using flow meters or similar type sensors to individually and collectively control the priming process and the reduction of RPM process. A typical location of a flow measurement device 201 is shown by way of example, and not limitation, in FIG. 2. Device 201 is shown on the input to motor 210, but could be positioned at the output of motor 210 or anywhere in the hydraulic system where an indication of the flow though pump 210 could be measured. When flow meters or flow measurement devices are incorporated the pressure sensor safety techniques described in the present description can replace pressure with reduced flow causing an alert or alarming an operator, or stopping the pump operation for a period of time to allow a person being held down by the suction forces to break free from the suction forces.

Other embodiments include automatic priming software to control the priming sequence described above along with software to control the reduced RPM operation of one or more pumps in a multiple pump configuration. Control logic contained anywhere in the system coordinate the operation making sure all pumps are properly primed and after proper priming provide concurrent switching of the pumps to reduced RPM operation.

To further simplify the design, configuration, startup and operation of the novel system described herein pool contractors (people who build and install pools) and pool maintenance people will have access to an Internet based or computer software based “pool hydraulic design” program or web site. The program or website allows pool related input data to be input such as pool dimensions, pool equipment location, topology data about the location of the pool equipment in relationship to the pool itself and the program or web site calculates one or more of the following:

a. Output a hydraulic design schematic employing one or more novel elements contained in the present description.

b. Output a hydraulic design schematic employing one or more novel elements contained in the present description including any flow rate compensation bypasses required

c. Output a bill-of-material listing for some or all of the parts required to build the hydraulic system or the pumping system or the pool controller or any other parts of the pool system

d. Output a theory of operation on one or more of the various components or design concepts used in the pool, optionally including calculations.

e. Provide an estimate for the motor operating RPM for each pump used in the system.

f. Output an energy savings when compared to a conventional pool design

g. Output other system related data or information. For example, but not limited to, provide priming mode RPM, filter mode RPM, spa jet mode RPM, service mode RPM, and other system operating data

h. Output other system related data or information pertaining to temperature run time calculations

i. Output recommended filter operating schedules

j. Output recommended filter operating schedules for the VSC adaptor unit described later in this application

k. Output pool to pool variability (field adjustment) recommendations

The software or program used to output the pool or pump related information above uses one or more of the following factors when processing:

1. pump location from the pool

2. in pools that have ‘vanishing’ edges the edge length of the pool

3. trough size for trough balance calculations

4. pool plumbing dimensions

5. edge flow compensation wherein the edge pump may need to run at higher RPM than the filter pump to provide more water flow to the vanishing edge feature of a pool

6. plumbing factors

7. other pool related data

In another novel aspect of the present embodiment flow measurements will be used to provide automatic pump priming and reduced pump RPM operation after priming. In one embodiment a flow sensor is affixed to each input and output line on each pump in the system. For cost reduced systems in other embodiments as little as a single flow sensor in a system is used. A multiplicity of alternative variations of the number of flow sensors used are contemplated. Any form of flow sensor can be used including, but limited to, paddlewheel sensors. The pump controller will monitor the flow rate of each pump using flow meter input and adjusts the pump RPMs based on flow rate. The pump controller will use one or more input factors when computing the flow rate selected from any one or more of the following:

1. Minimum flow rate required to properly filter a pool based on the desired operating schedule for the pump in hours per day

2. The most efficient pump operating level in terms of the energy consumption data and flow rate data for a pump

3. A flow rate appropriate for the physical dimensions of the pool including special features that may require more water flow such as vanishing edges and other water features

In designs with flow meters the water flow will also be used to determine problems with the hydraulic system such as blocked inlets, leaks, etc.

In multiple pump pool designs when operating with reduced RPM the flow rates should be equalized between the various pumps. This flow rate equalization will be achieved by running each pump at an RPM that provides the pump sufficient pump output back pressure to make sure the pump is not running dry (i.e. insufficient water input and output to keep the pipe full of water). There are a multiplicity of alternative means to achieve this including, without limitation, using flow rate input sensor or looking at the water flowing over a vanishing edge, or flow through a pipe, or water flow though a pump. In terms of adjusting the RPM for multiple pumps the following is an exemplary sequence:

a. Prime edge pump first

b. Prime filter pump second

c. Drop both pumps down until an even and thin flow of water over the vanishing edge is occurring (if there is a vanishing edge)

d. Depending upon the pool physical operate both pumps at or near same RPM, or drop one pump 100 to 200 RPM lower than the other should one section of the hydraulic system need more water flow. For example, the vanishing edge feature may require more water flow than the filtration system and the vanishing edge pump will operate at a higher RPM with higher water flow than the filtration portion of the system.

e. In pool designs that use a surge tank for the hydraulic system running the filter pump at a lower RPM than the edge pump will prevent surge tank overflow

The above RPM adjustment is only one example of how RPM should be performed. Other techniques can be used that will provide similar results and this invention should not be limited to the example provided above. In pool designs without vanishing edges both pump motors may operate at or near the same RPM or at different RPMs depending upon the physical design of the pool.

Conventional pools can operate in different modes depending upon the pool valve settings. Typical plumbing and valve design allows for a pool to operate in filter pool only mode, filter pool and spa, or spa-only mode. When pool is in spa-only mode and only the spa is being used, the system design may need a spa manifold off the spa pump to bypass pool water flow away from the spa otherwise there is too much water flow in the spa. The flow rate compensation bypass design as shown by way of example, and not limitation, in FIG. 2 or other water flow rate diverter can be used in such systems where bypass is needed.

In the present invention alternative methods of switching from startup to normal operating modes are contemplated including, without limitation, the following sequences:

f. Start up at full speed and run at full speed for a period of time before switching to reduced RPM mode.

g. Start up and operate at reduced RPM mode

h. Start up at a higher speed than reduced RPM mode and then ramp or switch to reduced RPM mode

In the present description “normal” or “reduced RPM mode” is used to refer to the mode used to describe the operating mode of the filter pump system in the routine daily filtering of the pool and is not the service mode or pool vacuuming mode or pool start up mode of operation. Likewise, normal or reduced RPM mode may be replaced by a spa mode that will be used for spa jet water flow when the pump system is used to replace a dedicated spa motor.

The safety of all existing and new pools is increased with an optional pressure sensor release device that embodies another novel aspect of the present invention. A pressure sensor or multiple sensors are added to the pool system design and the pressure sensor detects an increase in suction pressure indicating that a water inlet is blocked in some manner. There are many different ways pressure sensors can be added to the pool system. One embodiment of the design adds a pressure sensor 202, shown by way of example, and not limitation, in FIG. 2, to each input line while other designs use shared pressure sensors. The pressure sensor indicates an unsafe inlet pressure and the pressure sensor output signals the pump or pumps or pool control system that an unsafe condition exists. The pump or pumps will be turned off to release the suction and an optional alarm will be activated. Additionally a mechanical bypass will release the pressure in the line preventing a vacuum condition in the plumbing from maintaining suction force on the item trapped in the water inlet. Pool or pump software or control logic monitors the inlet pressure and upon detecting an unsafe condition for a short period of time will stop the motor operation for a period of time. Pump operation can automatically restart after a short period of time such as after 1 to 15 minutes after a high suction pressure condition, or an hour or more after the event. Or, pump operation my only resume after an alarm condition has been removed when a person activates a “clear alarm” input. Another novel element of this invention is to monitor water flow through a pump to using sensor 202 to detect a hazardous condition when reduction of loss of flow is detected triggering an alarm or alert condition.

Preferred embodiments of this invention adjust the time the filter operates per day based on the pool water temperature. In the winter when the water is cooler there is less bacteria growth due to the cooler water than in the summer when the water is hotter. In addition, people are less likely to swim for long periods of time in 65 degree water than in 82 degree water. Because of temperature related factors one embodiment of the electronic controller or pool computer controller includes a temperature input to allow the controller to adjust the number of hours per day that the pool filtration equipment operates. An example, without limitation, of how the filter run time minutes is shown in the table below. The table below is only an example of how the run time minutes are adjusted for a pool and there are many different values that can be used to increase pool efficiency adjustable run time filter operating minutes based on water temperature and the time of year. Optional time of year compensation adjusts the filter run time minutes for the different seasons where for example in the winter there is less organism growth due to the reduction in sun light and the reduced strength of the sun in the winter require less minutes of filter operation. In some embodiments, control electronics for pool can optionally have input data values for pool size and size of pool pipe size and these input data values are used in computing pool filtration run time computed by electronic controller.

Water Temperature—Run Time Minutes

Table 1 provides exemplary pool filtration run time minutes adjusted for the different number of minutes required based on water temperature.

TABLE 1

| | Water Temperature in degrees | | | | |
|---|---|---|---|---|---|
| | <70 | 70 to 75 | 75 to 80 | 80 to 85 | Above 85 |
| Filter | 120 | 140 | 180 | 240 | 300 |
| runtime in | | | | | |
| minutes | | | | | |

Water Temperature with Seasonal Run Time Minutes

Table 2 provides exemplary pool filtration run time minutes based on the time of year and water temperature.

TABLE 2

| | Water Temperature in degrees | | | | |
|---|---|---|---|---|---|
| | <70 | 70 to 75 | 75 to 80 | 80 to 85 | Above 85 |
| Summer | 120 | 140 | 180 | 240 | 300 |
| filter | | | | | |
| runtime in | | | | | |
| minutes | | | | | |
| Winter filter | 90 | 115 | 140 | 180 | 240 |
| runtime in | | | | | |
| minutes | | | | | |
| Spring filter | 110 | 130 | 150 | 220 | 270 |
| runtime | | | | | |
| minutes | | | | | |
| Fall filter | 95 | 120 | 150 | 190 | 260 |
| runtime | | | | | |
| minutes | | | | | |

Tables 1 and 2 are provided for illustrative purposes only and the invention should not be limited to only those shown in the above tables. Other adjustments of the filter runtime minutes based on water temperature, or water temperate and time of the year are contemplated by this application. In addition different graduations in the above tables are also contemplated with different temperature ranges, such as, but not limited to, 4 degrees per entry, 3 degrees per entry, etc. and different time ranges, such as, but not limited to, monthly, weekly, etc.

In another preferred embodiment the efficiency of currently installed pools using high speed pumps and 2″ or other sized plumbing is enhanced by another novel element that adds variable speed pump motor control to existing pool pumps and is referred to as the Variable Speed Controller or VSC. VSC varies the speed of pumps using a combination of commercially available variable speed motor control hardware and intelligent pump motor control logic or software to decrease energy consumption of pool pumps by operating the pump at a lower RPM than the RPMs provided by the pump at full power. For example, without limitation, VSC modifies the pump voltage resulting in a lower RPM than full power and the lower RPM results in lower pump energy consumption.

There are many ways to add the VSC process to existing or new pumps including, without limitation, the implement of VSC in hardware logic, a software or firmware program or any other form of hardware or software including combinations of hardware and software. The novel elements of VSC should not be limited to the physical implementation of the control circuitry. In one VSC embodiment a retrofit unit is added that connects between the pump main power supply and the motor to add variable speed motor control to the pump.

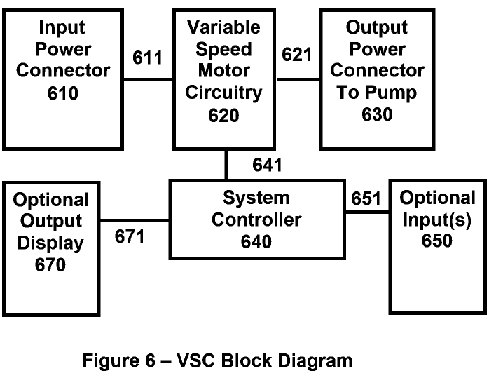

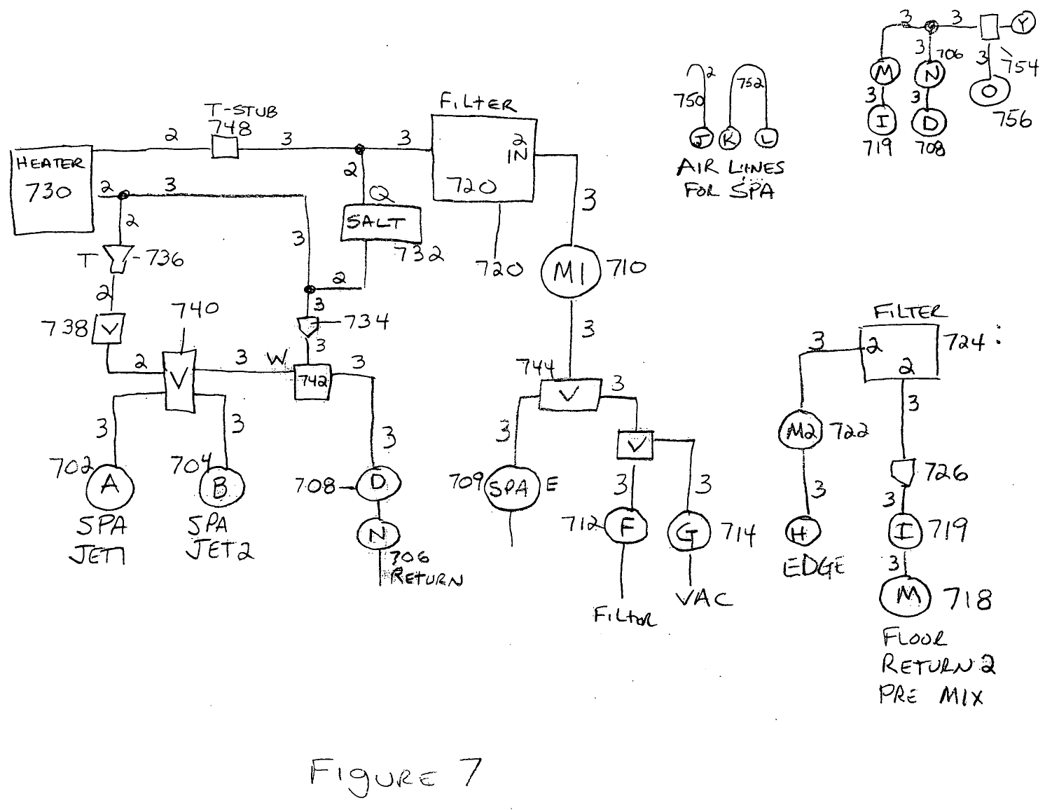

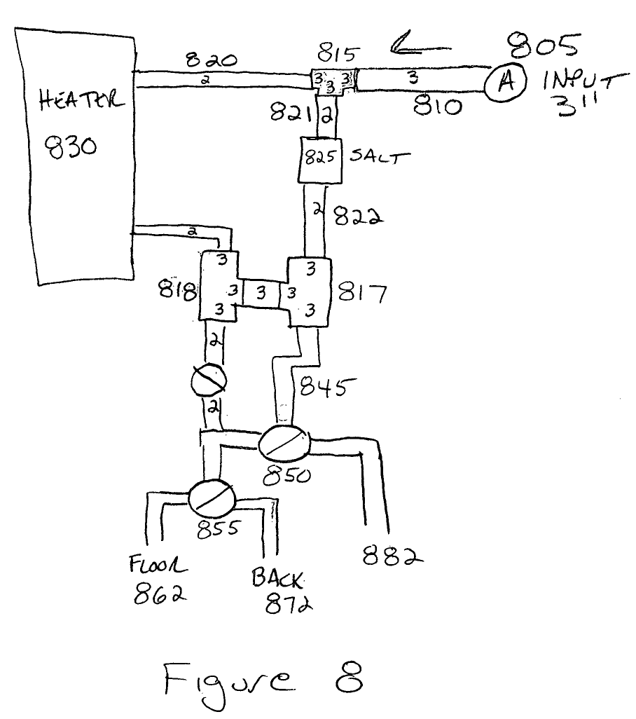

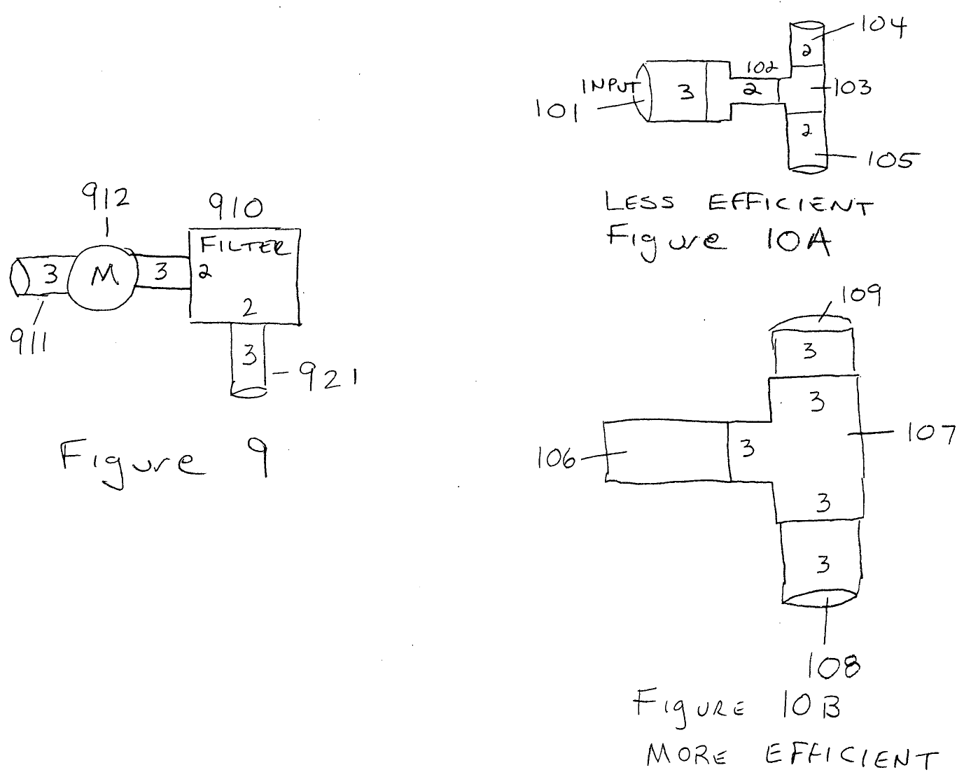

FIG. 4 shows a simplified diagram of a pool controller connecting to a motor in the prior art. In the Figure, the power and control signal wiring is shown in simplified form as “Motor Power and Start Signal” 420. Motor Power and Start Signal is the normal conventional wiring connections to provide power to the motor and wiring to connect the pool or pump controller to the motor. Motor Power can be single phase or multiple phase motor power connections to the pump and do not have to originate at the Pool Controller and can us separate wiring from the Start Signal. The Start Signal can be one or more motor control signals used by conventional pool equipment.

FIG. 5 illustrates an exemplary diagram for the connection of a VCS to a pool controller and a motor in accordance with an embodiment of the present invention. The exemplary VSC shown as element 560 in FIG. 5 modifies the main input voltage, such as 240 vac for example, without limitation, portion of the Motor Power and Start Signal 420 and transforms the input power portion of 420 and any control information on the same signal 420 into a form of power or motor signaling that operates motor 420 at variable speed. Variable Speed Motor Power 570 includes variable speed motor power and/or control signals that cause the motor RPM speed to vary and thus causes the pump motor 430 to operate at variable speeds. Variable Speed Motor Power 570 connection to motor 430 includes the normal motor 430 power connection and motor control signals, if any, used in conventional motors. VSC 560 can use any form of variable speed motor pump control as discussed below.

The modified output voltage, or voltage and control, or current from the VSC 560 is referred to as Variable Speed Motor Power 570 and output from the VSC 560 is connected to the pump 430. Various forms of variable speed motor control circuitry can be utilized for Variable Speed Motor Power 570, and include hardware and/or software. The circuitry can include, but not limited to, techniques that modify the pump voltage, frequency of the power applied to the pump, pump voltage waveform of voltage, current, or phasing, voltage level applied to pump, variable frequency motor drive, pulse width modulation, variable-frequency drive (VFD) for AC or DC motors with AC or DC input voltages, switched AC, modulated AC, switched DC, pulsed DC, Proportional Integral Derivative (PID) control, variable frequency drives, or any other motor speed control technology. In addition to be referred to as variable speed motor control circuitry the terms power switching or power waveform modification circuitry will also be used to describe the circuitry that modifies the motor operating RPM using anyone of the above techniques. The invention should not be limited by the actual motor power technology applied to vary motor RPM and achieve efficient pump control and any motor control technology can be applied in ones that will be invented in the future.

A variable-frequency drive (VFD) is a system for controlling the rotational speed of an alternating current (AC) electric motor by controlling the frequency of the electrical power supplied to the motor. A variable frequency drive is a specific type of adjustable-speed drive. Variable-frequency drives are also known as adjustable-frequency drives (AFD), variable-speed drives (VSD), AC drives, microdrives or inverter drives. Since the voltage is varied along with frequency, these are sometimes also called variable voltage variable frequency (VVVF) drives.

Embodiments may use of any form of motor control as discussed above along with VSC's being design for single-phase and multiple-phase input voltages and VSC's outputs appropriate for a single-phase motors or multiple-phase (3-phase) motors. In one embodiment, the VSC outputs a single phase output voltage. In another embodiment, VSC outputs a three-phase output voltage. Another yet embodiment of the VSC outputs single-phase or 3-phase voltages.

VSC operates the pump in two or more modes called “priming mode”, “variable speed mode”, “service mode”, or “filter mode” or other mode. The prior listed pump operating modes are exemplary and the minimum number of modes contemplated by this invention is two with those being “priming” and “variable speed mode” for reduced pump RPM and reduced pump energy consumption. At initial pool startup the pool system needs the pool pump primed with VSC operating in priming mode. Priming mode is used to establish a solid flow of water through the hydraulic system. Pump priming typically occurs at high speed or close to high speed. Once a pump is primed the motor efficiency of a pump is increased by running the pump at a lower RPM than the priming speed or a lower RPM then the normal fixed pump operating speed. In single speed pumps the pump will operate at one pre-determined voltage and RPM that is, in most cases, determined by the fixed operating voltage for the pump. For pool pumps the rated operating voltage is typically 110 VAC or 220 VAC and a single speed pump will run with this operating voltage applied. VSC will apply a voltage close to, or equal to the normal operating voltage for the pump during priming mode. Priming time is the amount of time the Motor Control keeps the motor operating at or near full RPM. Priming time can range from as little as less than 0 seconds for no priming and start immediately in variable speed mode, to more than 30 minutes. An 8 to 15 minute priming time is one example, without limitation, of a default time for priming.

In the examples the VSC device is shown controlling a single pump, however multiple pump support can be included in the VSC to provide power for multiple pumps using a single or multiple power output connectors.

Contained within Variable Speed Controller 560 device is a combination of variable speed motor control circuitry as discussed above and in other parts of the present description and motor control logic or software that controls the operation of the motor and this control or software and is referred to as Motor Control Logic. Logic in the Motor Control times the operation of the different modes and switching between modes is controlled by Motor Control circuitry, or pool controller with Motor Control Circuitry, pump incorporating Motor Control circuitry, or a retrofit circuitry contained in a VSC retrofit unit that is a standalone box added external to the pool controller or pump. Imbedded logic with VSC eliminates the need to modify the pump control sequence programmed into the existing computer pool controller for the pumps being converted from single speed operation to variable speed operation. Only the pump control schedule will need to be modified, increasing the number of pump and filter run time minutes to compensate for the reduced water flow in the system resulting from the lower operating speed of the pump.

Motor Control Logic or other logic performs one or more of the following motor control functions:
Normal Operation (or Reduced RPM mode) with VSC or Motor Control Logic:

a. Pump starts with motor at or near full speed due to application of motor power or motor start signal from controller.

b. Motor Control switch from full speed motor operating to a lower RPM after a programmable time interval in the range of less than 1 second to 30 or more minutes
Pool Service Mode:
Operate Pump at full speed.
Spa Mode:
Operate single system pump or in multiple pump configurations with the motor used to provide high water pressure or high water flow to spa back jets. Depending on how the spa pump is configured the Spa Mode operation may be at a higher or lower or the same RPM as one of the other modes. One skilled in basic pool system plumbing will know how to set the valve or valves necessary to direct the flow of pool water to the Spa.
Vacuum pool:
Operate Pump at full speed, or near full-speed, or priming speed or at appropriate RPM for vacuuming pool
Variable Speed:
Vary the speed of the motor based upon input from the pool controller or a remote control signal, or a RPM up/down switch, or other signal coupled to Motor Control circuit, or by timer logic in Motor Control. When the RPM up/down control signal is inactive Variable Speed pump operation is the same as the low RPM mode of the normal mode above except that the new RPM operating speed of the pump is remembered by the System Controller or another element of the pools system and the new RPM operating speed becomes the normal VSC operating RPM.
Adjust RPM Up/Down
An optional RPM adjustment input switch or control signal provides input to Motor Control signaling that the pump RPM should be increased or decreased based on the input signal or signals. In this mode Motor Control circuits signals the power switching or power waveform modification circuitry to adjust the motor RPM.

Activation of any of the above modes, or any modes supported by the motor control circuitry or variable speed drive or pool controller can be simplified with the addition of a ‘mode’ convenience button. When the mode convenience button is pressed the corresponding operating mode is activated.

Any of the operating modes supported by the motor control circuitry or variable speed drive or pool control can optionally include an automatic time out to switch out of the mode. For example, without limitation, if Service Mode is activated and the service person forgets to take the equipment out of Service Mode a timer will automatically switch the equipment back to a low RPM or energy efficient operating mode.

Some alternative embodiments of the present invention may include intelligent switching of the above modes. For example, without limitation, if the pool is running in normal operating mode and the spa mode is activated the pump speed will be appropriately switched and likewise when the spa mode is turned off and the normal operating mode was selected before the spa mode was activated the motor pump speed will return to normal operating mode.

Other embodiments of the present invention may also include one or more “convenience switches or inputs” that when pressed or activated switch the system into a selected mode. For example, without limitation, a ‘service’ mode switch or input on any one of the electrical or electronic components described herein will switch the operating mode of the system to a service mode that allows a pool service technician to perform pool cleaning and servicing functions. Another optional convenience switch can be provided to switch the pool out of service mode and into a lower motor RPM than service mode, or Spa mode, etc. There are many different operating modes or settings that can be selected by optional convenience switches or inputs.

An example, without limitation, of automatic switching from priming mode to variable speed mode is presented below:

a. Pump power is applied from pool controller or by power being applied to pump; by way of example and not limitation, switching on 240 VAC to start pumping.

b. Motor control starts pump at full speed or a high speed

c. After a priming time Motor Controller reduces RPM of motor

d. Feedback from optional flow rate sensors when incorporated in a pool control system are used to adjust pool motor operation to a flow rate efficient motor speed at lower RPM (called lower RPM mode)

e. Lower RPM mode is used for normal daily pool filtration

It is also contemplated by this invention that pump start, priming, and switching modes other than those described herein are supported.

VSC retrofits pump hydraulic system without requiring the installation of a new pump computer controller. Conventional efficient pumps that support variable speed pump operation generally cannot be driven from existing pool control systems and require a new and expensive computer control system to be installed. Furthermore, these new and expensive variable speed pool and pump controllers require complicated programming and setup. Complicated programming and setup is in many cases too difficult for pool contractors and pool installers and as such the variable speed pumps are programmed to operate at a single speed eliminating the potential energy savings offered by variable speed pump. One application of the VSC is to convert single speed pumps to variable speed operation, another application of the VSC is to simplify the control of variable speed pumps. The VSC applied to variable speed pumps simplifies the setup, control, programming, and operation of the variable speed pump when compared to conventional variable speed programmable pump pool controllers thus eliminating the need for a new and expensive pool computer controller. Additionally a simpler, lower-cost pool computer controller can be implemented and even pool computer controllers that normally cannot control variable speed pumps can be used with variable speed pumps because of the advantages offered by the VSC including pre-programmed operating modes, simple installation, and use of single speed pump control signals output by conventional pool controllers to activate different operating modes within the VSC.

FIG. 6 illustrates an exemplary block diagram of a VSC in accordance with an embodiment of the present invention. Input Power is connected to the VSC adaptor at Input Power Connector 610. Input power can be any form of Alternating Current (AC) or Direct Current (DC) power. Input Power connects to VSC device via any form of connector or terminal block or power cord. Depending upon the existing pump power, Input Power in most applications will be the normal power and voltage applied to the pump prior to adding the VSC adaptor. The power wiring connecting input power to the pump will be removed and attached to the VSC Input Power 610. Input power connects to Variable Speed Motor Control 620 circuit via physical electrical connection shown as 611. Variable Speed Motor Circuitry 620 can be any form of motor speed control circuitry as described in other parts of the present description. Input Power to VSC may also contain pump start and other pump control signals on the high voltage power input to the VSC or on one or more separate control inputs to VSC.

In the preferred embodiment shown, system Controller 640 is the central controller of the system providing pump mode sequencing control as discussed in other parts of the present description. System Controller 640 can be implemented using hardware or software or a combination of both and provides Variable Speed Motor Circuitry 620 with signals that Variable Speed Motor Control Circuitry 620 to modify the output power. While shown as a separate box by way of example in FIG. 6, System Controller 640 can be incorporated into other elements contained in the diagram. System Controller 640 stores the operator adjusted RPMs for each of the supported modes by a VSC. For example, without limitation, when VSC supports Priming, Normal, Spa, and Service modes, then System Controller 640 will store RPM settings for one or more of these modes in non-volatile memory, or other memory for use by System Controller for store/recall of RPM setting for the mode. VSC can be programmed for predetermined operating RPMs for each mode, or for default RPM speed for the different modes. When supported by VSC, operator uses switch to increase/decrease RPM for a particular mode and System Controller 640 stores RPM setting in memory (not shown). System controller contains control logic in the form of firmware program, hardware logic, or a combination of firmware and hardware to provide control of Variable Speed Motor Control 620 circuitry and other control functions required by VSC such as monitoring optional inputs, outputting message to optional display, and sequencing Variable Speed Motor Control 620 timing and outputs.

Variable Speed Motor Circuitry 620 connects to System Controller 640 with signals on connection 641 appropriate for Variable Speed Motor Control Circuitry 620. Appropriate control signals 641 will be at the required signal, timing, and message format to sequence power output from Variable Speed Motor Control Circuitry 620. Signal or signals found on 641 can be any form of appropriate signal interface including, but limited to, interface to opto-isolation, transformers, or capacitors or other form of signaling with appropriate isolation protection to prevent the input or output power from creating hazardous and potentially lethal conditions due to improper isolation.

Optional Output Power Connector to Pump 630 is a connector, terminal block, or connection from the VSC to the pump motor power input. Contained on this connector is the modified power that is connected to the pump or motor to operate pump or motor at a variable speed. Output Power Connector to Pump 630 is provided for illustrative purpose only and the connection between the Variable Speed Motor Circuitry 620 can be made by a direct connection of connection 621 to the motor.

While FIG. 6 provides an example of the VSC elements in the form of a stand-alone adapter with separate input and output power connections, it should be appreciated that one or more of the elements shown in FIG. 6 when added internally to a pump or internally to a pump controller will provide the expected benefits of the VSC controller within the pump or controller eliminating the need for a stand alone VSC device. By way of example and not limitation, one application of the VSC controller in a standalone unit is to retrofit existing pool equipment where adding the VSC functionality to a pump or controller is not practical.

Also shown by way of example, and not limitation, in FIG. 6 is Optional Inputs 650 connecting to System Controller 640 via connection 651. Optional Inputs 650 are used to provide additional operating modes and conditions for the pump based on optional inputs to Optional Inputs 650 such as flow meters, temperature sensors, VSC or pump control switch inputs, described below, and other input signals. Optional control switch inputs connected to Optional Inputs 650 can be used to force the operating mode of the VSC or Pump or Pump Controller into one of the supported modes. For example, without limitation, a switch connecting to Optional Input 650, when included, sets the mode of operation based on switch activation. As a non-limiting example, pressing the switch once will switch to Service Mode, pressing twice will switch to Vacuum Mode, pressing three times will switch back to normal Variable Speed operating mode. One or more switches can be used to switch modes. An optional Light Emitting Diode (LED) or similar, or display message (both not shown), when included, indicates the operating mode of the VSC, or pump, or controller operating mode. As set forth in the foregoing description, the VSC circuitry can be contained in a standalone physical device or added to circuitry found within a pump or pump controller. An optional output display 670 is connected to System Controller 640 via connection 671 and display 670 is used to provide visual display to operator. Display can be any type of visual display including, but not limited to, Light Emitting Diode (LED), Liquid Crystal Display (LCD), Plasma display, vacuum florescent or any other display technology. Optional Display 670 can be used to provide display status messages such as, but not limited to, the operating mode or operating RPM, or operating energy consumption or any other type of message.

Depending on the needs of the particular pool controller, and/or the hydraulic system/valves implemented in the system, Optional Input 650 may be configured to include a signal to operate in the “Spa Mode” of operation or other suitable modes of operation based on signals output from pool controller or control switches or control signals contained in the system. Those skilled in the art, in light of the present invention, will readily recognize how to configure the controller and its optional signals and inputs depending on the needs of the particular application. For example, without limitation, Spa operating mode is signaled by existing pool controller and this signal will be connect to one or more signal lines on Optional Input 650 to activate valve switching for spa mode as well as the operating RPM for the spa jets. In Spa Mode pump RPM is variable to allow for low-jet pressure or flow, higher-jet pressure or flow and maximum jet pressure or flow.

One or more optional flow sensors or pressure sensors connecting to Optional Input 650 provide input to support the various measured flow rate controls and modes described in other areas.

An optional Output Control (not shown) added to the block diagram in FIG. 6 provides output signals using correct voltages, currents, or messaging necessary for controlling other components contained in the pool system. For example, without limitation, typical signal output means include an opto-isolated output signal, or switched relay signal, or computer message output from VSC will control pool system elements such as a suction fault indicator, or switching for a hydraulic system valve when necessary. Output Control (not shown) can provide control signal or signals, or system status signals, or computer messages to other system components, or any combination of output signaling including switched voltage, switched relay contacts, MODBUS, Ethernet, wireless, opto-isolated, Transistor-Transistor Logic (TTL) or other logic (CMOS, 3.3 volt, 1.8 v, 1.3 v logic levels for example). Output Control signals are incorporated in VSC standalone device, or pump or controller when appropriate.

In the present embodiment, because VSC reduces the operating RPM of the pump or pumps used in a pool, the VSC or pool controller or pump will compensate for the reduced operating RPMs and reduced water flow resulting from application of the VSC. Depending upon the pool system components, the reduced pump RPM operating speed may require an increase in the number of pump runtime minutes when filtering a pool. The increased run time pool minutes can be programmed into the controller or can be automatically compensated for by the System Controller 640 in FIG. 6. The existing pool controllers found in conventional pools are programmed to operate for 4 hours a day to provide adequate pool filtration and this time may need to be increased because of the reduced flow resulting from VSC reduced RPM mode. Depending on the pool no increase in filtration time may be necessary or a doubling or more in the filtration time maybe required when operating in reduced RPM mode for reduced power consumption and more efficient pump operation.

Extending the operating hours to compensate for the reduced flow in variable speed mode, can be programmed in the pool controller or pump logic, or VSC System Controller 640. Even though the pump will be operating for more hours in variable speed mode the VSC generates large energy savings per day when compared to full speed conventional pump operation of conventional pumps. In field tests VSC reduced RPM operating mode power consumption to 460 watts (2 amps of current at 230 VAC) compared to 2300 watts (10 amps of current at 230 VAC) in the normal operating mode without VSC. Total power consumption in VSC mode was reduced from 2300 watts of power per hour to 460 watts per hour. On a daily basis the energy is reduced from 18.4 kilowatts in an 8 hour normal pump speed operation mode to a VSC power consumption of 4600 watts based on a 10 hour VSC operating mode. This savings is achieved without impacting the pool water quality. Assuming an 18-cent per kilowatt peak energy cost the pool without VSC costs $3.31 per day to operate compared to the VSC controlled pool operating in reduced RPM mode cost of $0.83. Annualized over a year the savings with a VSC based pool will be in the range of $900 providing additional benefits such as the reduction of C02 emissions and reduction of peak power demand energy that needs to be provided to the power grid by energy companies.

Torque Mode Control

In a preferred embodiment, another novel element is the detection of a potentially hazardous condition within the filtering system wherein hair or a body part of a person or animal is sucked into the pool filtration system entrapping an individual or an animal underwater and resulting in drowning. As set forth in the foregoing description, pool filtration systems create hazardous suction pressures that can prevent an individual from breaking free of the suction. In addition, entrapment or blockage detection detects loss of input fluid that can cause the motor to fail prematurely due to the pump running dry.

Referring now to FIG. 6, the variable speed motor circuitry (620) operates in what will be called a ‘torque mode’ of operation, wherein the motor is set to generate a predetermined amount of motor torque by the variable speed motor control circuitry 620. While FIG. 6 shows an exemplary variable speed motor circuitry 620 providing output power to a pump via output power connector to pump 630 connector the techniques described herein can be applied to any form of motor control/monitoring electronics incorporated in a variable speed drive, a pool controller, a computer, a combination of computer hardware and software, or any other form of electronic circuitry or electronic control and individually or collectively will be referred to in herein using the term variable speed motor control circuitry or motor control circuitry. There will be many different ways known in the art of motor control and variable speed motor circuitry design to program electronics to operate in torque mode, including, but not limited to, closed loop and open loop circuit designs incorporating proportional integral controller and other techniques.

When the pool motor is adjusted for an operating mode, the service person adjusting the pump will adjust the amount of flow being generated by the pool pumps by a control input to the motor control circuitry. The service person will increase or decrease the water flow using input keys on the motor control circuitry or by turning a potentiometer used to control pump flow or other suitable method. Once sufficient water flow has been set by the service person, the pool controller or variable speed drive or computer controlling the pumps will set the motor control electronics to operate the pump in the selected mode with the current amount of torque being generated by the pump.

The control of the water flow is now controlled by setting the motor to operate with a set amount of motor torque. Under normal operating conditions, the pool hydraulic system will not be impeded and will be filled with water, the load on the motor will be fairly constant and the load on the motor will be close to the load on the motor when the service person set the operating mode. As such, the motor will be operating with a load close to the motor torque that was set by the service person.

At this point the actual motor RPM was not used to control the flow being generated by the pump. In torque mode and under normal operating conditions a motor operating parameter such as RPM will be fairly consistent, however when the load on the motor changes the motor RPM will vary depending upon the change in the load. This is at least because the motor controller is trying to keep the motor operating at a constant torque and the load change results in the motor changing RPM while trying to deliver a constant torque. In torque mode the RPMs will increase when the water is sucked out of the intake lines, for example when one of the intake lines is blocked. The variable speed motor control circuitry will detect the increase in RPM exceeding a predetermined threshold value and if this condition persists for a predetermined amount of time the variable speed motor control circuit will shut the motor off and optionally signal a fault condition. In the event the fault condition was caused by entrapping a person's body part in one of the hydraulic system inputs the suction pressure entrapping the individual will be released when the motor shuts off.

In another embodiment, an alternative method to determining entrapment is to monitor the operating parameter of the motor corresponding to the current being consumed by the motor and this mode will be called current monitor mode. There are many ways to measure current in the system and any method can be used. Entrapment is determined in current monitoring mode by measuring the current in an operating mode after the operating mode is set and then setting high and low current change thresholds that when exceeded for a certain period of time result in the variable speed motor control circuitry shutting off the motor. The current can be monitored at any point in the system including, but not limited to, any circuit node in the variable speed motor circuitry. While torque, rpm, and current modes have been described for detecting blockage and entrapment it will be readily apparent to those skilled in the art, in light of the present invention, that, depending upon the needs of the particular application, other suitable motor controller (VSC) parameters can be effectively used to detect blockage and entrapment.

FIG. 12 illustrates a flow chart for an exemplary Torque Mode operation and monitoring RPM in accordance with an embodiment of the present invention. In FIG. 12 the pump is set to the desired operation model in the step labeled Set Pump Operating Mode 1210, setting the motor to one of the programmable operating modes such as, but not limited to, efficient mode, normal mode, service mode, spa mode, etc. In step 1220 the motor control sets the motor operating torque value setting the motor operating torque. In addition, low and high RPM thresholds are set. In one example, and not by way of limitation the low and high RPM thresholds are set as a percentage from the current operating RPM. In step 1230 the motor is operating with the torque value setting set in step 1220. At this point, in a system without blockages, the motor will be operating at an RPM level similar to what was measured when this operating mode was set up by the service person. A RPM monitor loop is performed in steps 1240 Monitor RPM and step 1250 check for RPM Out Of Range. Step 1240 reads the current RPM level and performs any averaging or filtering on the RPM reading. Step 1250 tests to see if the current RPM reading obtained in the Monitor RPM step 1240 is out of range. Out of Range test 1250 check to see if the current RPM reading, averaged or filtered, is above the High RPM Threshold set for this operating mode in step 1220. Out of Range test 1250 also checks to see if the current RPM reading obtained in Monitor RPM 1240 is below a Low RPM Threshold determined when the operating mode of the motor was configured by a service person or at the factory during manufacturing. When the RPM Out Of Range test 1250 indicates that the RPM value is not out of range the conditional test branch path for not out of range, NO path 1252, is executed and the RPM monitor loop continues monitoring the motor RPM. In the event one of the two RPM thresholds is exceeded, either RPM too high, or RPM too low, the RPM Out Of Range 1250 Yes (or True) path 1254 is taken and the motor is shut down in Shut Down Motor 1260. Additionally, an optional Signal, or fault logging Fault step 1270 is performed. The motor can remain shutdown until another signal, such as, but not limited to, timeout expiring or keypad input or control input or other, indicates that the motor should resume operation. Motor can resume operation at Set Pump Operating Mode 1210 or Operate Motor with Set Torque Value 1230 or another state that resumes normal pump operation. Depending upon motor start up sequence there may be an automatic priming mode that occurs before the Set Pump Operation Mode 1210 step, such as, without limitation, when power is applied to pump, or as part of this step. It should be noted that that any suitable form of averaging, filtering, or timing may be alternatively implemented in this or any other monitoring loop or control loop of the present invention. The various thresholds described for Out Of Range, RPM too high or too low, current too high or low, etc., can be set to a wide range of values depending upon the sensitivity desired for an application. For example, without limitation, RPM thresholds of plus or minus 5 percent of the current mode operating RPM will result in a highly sensitive entrapment detection system that maybe appropriate for applications requiring high sensitivity. RPM thresholds of plus or minus 50% or more will be appropriate for low sensitivity applications. Similar threshold ranges can be used for the current monitoring mode of entrapment processing.

In another example, without limitation, for system control using current measurements, the high and low RPM thresholds can be replaced with high and low motor current thresholds and the RPM monitor loop, Monitor RPM 1240 and RPM out of range 1250, can be replaced with motor current monitoring. A control loop that checks the motor current is performed and if the motor current is too high or too low, exceeding a threshold, then the motor is operating out of range and the shut down motor 1260 and signal fault step 1270 are executed. In this example motor current monitoring replaces RPM monitoring to determine a motor fault.

In other embodiments a combination of torque monitoring and current monitoring can be combined within the motor control processing wherein at different times, or during all processing, both RPM for torque monitoring and motor current for current monitoring are monitored and checked to make sure the motor is operating within predefined limits.

Those skilled in the art will readily recognize, in accordance with the teachings of the present invention, that any of the foregoing steps and/or system components may be suitably replaced, reordered, removed and additional steps and/or system components may be inserted depending upon the needs of the particular application, and that the systems of the foregoing embodiments may be implemented using any of a wide variety of suitable processes and system components, and is not limited to any the particular ones described in the present application.

Having fully described at least one embodiment of the present invention, other equivalent or alternative methods of hydraulic design and pump control according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method of operating a controller for at least one pump motor, the method comprising the steps of:
setting an operating mode for the at least one pump motor;
setting a torque or RPM value operating the at least one pump motor corresponding to said operating mode;
setting a high operating threshold and a low operating threshold corresponding to said torque or RPM value;
operating the at least one pump motor in a constant operating mode using said torque or RPM value;
monitoring an operating parameter of the at least one pump motor corresponding to a load on the at least one pump motor; and
discontinuing operating the at least one pump motor when said operating parameter is higher than said high operating threshold or lower than said low operating threshold.

2. The method as recited in claim 1, further comprising the step of signaling a pump motor fault upon said discontinuing operating the pool pump motor.

3. The method as recited in claim 1, wherein said motor control value is torque and said operating parameter of the pump motor is RPM.

4. The method as recited in claim 1, wherein said operating parameter of the pump motor is RPM and the operating parameter is the electrical current supplied to the said motor.

5. The method as recited in claim 1, wherein the step of monitoring further includes monitoring sensors to determine if a blockage exists for the pool pump motor.

6. The method as recited in claim 5, wherein the step of discontinuing further includes discontinuing operating the pool pump motor when said blockage exists.

7. The method as recited in claim 6, wherein said sensors are a flow sensors.

8. The method as recited in claim 1, wherein the step of operating the pool pump motor further includes setting a runtime for said operating at least based in part on a temperature of water in a pool.

9. The method as recited in claim 8, wherein said setting a runtime is further based in part on a seasonal time of year.

10. The method as recited in claim 1, wherein the controller for a pool pump motor is configured to control at least a first pool pump motor and a second pool pump motor, wherein outputs of said first pool pump and said second pool pump are fluidly connected, said method further comprising the steps of:
turning on the first pool pump motor;
operating the first pool pump motor at a first high speed to prime the first pool pump motor;
turning on the second pool pump motor;
operating the second pool pump motor at a second high speed to prime the second pool pump motor; and
reducing said first high speed of the first pool pump motor and said second high speed of the second pool pump motor after both the first pool pump motor and the second pool pump motor have been primed.

11. The method as recited in claim 10, in which said reducing occurs generally simultaneously to mitigate effects of one pump's output overpowering another pump's output.

12. The method as recited in claim 10, further comprising the step of fine tuning a first operating speed of the first pool pump motor and a second operating speed of the second pool pump motor.

13. The method as recited in claim 10, further comprising the step of monitoring sensors to determine when the first pool pump motor and the second pool pump motor have been primed.

14. The method as recited in claim 13, further comprising the step of equalizing a flow rate between the first pool pump motor and the second pool pump motor, said flow rate equalizing using said sensors so that there is sufficient pump output back pressure on the first pool pump motor and the second pool pump motor to avoid the first pool pump motor and the second pool pump motor from running dry.

15. A variable speed controller configured to control at least a first pool pump motor and a second variable speed controller configured to control at least a second pool pump motor, said first and second variable speed controller comprising:
a variable speed motor circuitry in communication with said pool pump motor for operating the pool pump motor independently from other said variable speed controller and said pool pump motors at a plurality of different speeds; and
a system controller in communication with each of the said variable speed motor circuitry, said system controller being configured to signal said variable speed motor circuitry to turn on the first pool pump motor, operate the first pool pump motor at a first high speed to prime the first pool pump motor, turn on the second pool pump motor, operate the second pool pump motor at a second high speed to prime the second pool pump motor and reduce said first high speed of the first pool pump motor and said second high speed of the second pool pump motor after both the first pool pump motor and the second pool pump motor have been primed.

16. The variable speed controller as recited in claim 15, in which said signaling to reduce occurs generally simultaneously to mitigate effects of one pump's output overpowering another pump's output

17. The variable speed controller as recited in claim 15, wherein said system controller is further configured to signal said variable speed motor circuitry to operate the first pool pump motor and the second pool pump motor in a constant torque mode, monitor an operating parameters corresponding to loads on the first pool pump motor and the second pool pump motor and discontinue operating the first pool pump motor and the second pool pump motor when one of said operating parameters exceeds an operating threshold.

18. The variable speed controller as recited in claim 15, wherein said system controller is further configured to signal said variable speed motor circuitry to operate the first pool pump motor and the second pool pump motor in a constant RPM mode, monitor an operating parameters corresponding to loads on the first pool pump motor and the second pool pump motor and discontinue operating the first pool pump motor and the second pool pump motor when one of said operating parameters exceeds an operating threshold.

19. The variable speed controller as recited claim 18, wherein said operating parameter of the pump motor is RPM and the operating parameter is the electrical current supplied to the said motor.

20. A hydraulic system for a pool, the hydraulic system comprising:
a first water inlet from the pool;
a first pool pump motor having a first input and a first output, said first input being connected to said first water inlet;
a second water inlet from the pool;
a second pool pump motor having a second input and a second output, said second input being connected to said second water inlet; and
a connection for combining water from said first output and said second output, wherein the water is combined before being returned to the pool.

21. The hydraulic system as recited in claim 20, in which the connection for combining is located after at least one pool accessory.

22. The hydraulic system as recited in claim 20, further comprising a fluid bypass for bypassing a portion of said water feed from an input to an output of a pool accessory.

23. The hydraulic system as recited in claim 20, wherein said first water inlet is above said first input and gravity feeds water into said first pool pump motor in a flooded-suction manner.

24. The hydraulic system as recited in claim 23, further comprising an energy generating turbine inline between said first water inlet and said first input where said turbine generates electricity.

25. The hydraulic system as recited in claim 20, further comprising a variable speed controller configured to control at least said first pool pump motor and a second variable speed controller configured to control at least said second pool pump motor, said variable speed controllers comprising variable speed motor circuitry for operating said first pool pump motor and said second pool pump motor at a plurality of different speeds and a system controller in communication with said first and second variable speed motor circuitry, said system controller being configured to signal said variable speed motor circuitry to operate said first pool pump motor and said second pool pump at said plurality of different speeds to prime said first pool pump motor and said second pool pump.

26. A controller system for a pool pump motor, the system comprising:
means for setting an operating mode for the pool pump motor;
means for setting a torque value for the pool pump motor corresponding to said operating mode;
means for setting a high operating threshold and a low operating threshold corresponding to said torque value;
means for operating the pool pump motor in a constant torque mode using said torque value;
means for monitoring an operating parameter of the pool pump motor corresponding to a load on the pool pump motor; and
means for discontinuing operating the pool pump motor when said operating parameter is higher than said high operating threshold or lower than said low operating threshold.

27. The system as recited in claim 26, wherein the controller for a pool pump motor is configured to control at least a first pool pump motor and a second pool pump motor, and said system further comprising:
means for turning on the first pool pump motor;
means for operating the first pool pump motor at a first high speed to prime the first pool pump motor;
means for turning on the second pool pump motor;
means for operating the second pool pump motor at a second high speed to prime the second pool pump motor; and
means for reducing said first high speed of the first pool pump motor and said second high speed of the second pool pump motor after both the first pool pump motor and the second pool pump motor have been primed.

28. The system as recited in claim 27, in which said reducing occurs generally simultaneously to mitigate effects of one pump's output overpowering another pump's output.

29. A method for controlling a pool pump motor, the method comprising:
Steps for setting an operating mode for the pool pump motor;
Steps for setting a torque value for the pool pump motor corresponding to said operating mode;
Steps for setting a high operating threshold and a low operating threshold corresponding to said torque value;
Steps for operating the pool pump motor in a constant torque mode using said torque value;
Steps for monitoring an operating parameter of the pool pump motor corresponding to a load on the pool pump motor; and
Steps for discontinuing operating the pool pump motor when said operating parameter is higher than said high operating threshold or lower than said low operating threshold.

30. The method as recited in claim 29, wherein the controller for a pool pump motor is configured to control at least a first pool pump motor and a second pool pump motor, and said method further comprising:
Steps for turning on the first pool pump motor;
Steps for operating the first pool pump motor at a first high speed to prime the first pool pump motor;
Steps for turning on the second pool pump motor;
Steps for operating the second pool pump motor at a second high speed to prime the second pool pump motor; and
Steps for reducing said first high speed of the first pool pump motor and said second high speed of the second pool pump motor after both the first pool pump motor and the second pool pump motor have been primed.

31. The method as recited in claim 30, in which said reducing occurs generally simultaneously to mitigate effects of one pump's output overpowering another pump's output.

32. A method for controlling a pool pump motor, the method comprising:
Steps for setting an operating mode for the pool pump motor;
Steps for setting a RPM value for the pool pump motor corresponding to said operating mode;
Steps for setting a high operating threshold and a low operating threshold corresponding to said RPM value;
Steps for operating the pool pump motor in a constant RPM mode using said RPM value;
Steps for monitoring an operating parameter of the pool pump motor corresponding to a load on the pool pump motor; and
Steps for discontinuing operating the pool pump motor when said operating parameter is higher than said high operating threshold or lower than said low operating threshold.

33. A hydraulic system for a pool, the hydraulic system comprising:
a water inlet from the pool;
a pool pump motor having a input and a output, said input being connected to said water inlet, wherein said water inlet is above said input and gravity feeds water into said pool pump motor in a flooded-suction manner; and
an energy generating turbine configured to be inline between said water inlet and said input where said turbine generates electricity.
